(19) United States
(12) Patent Application Publication
(10) Pub. No.: US 2023/0063951 A1
(43) Pub. Date: Mar. 2, 2023

(54) WARNING SYSTEM FOR ROADSIDE OPERATIONS

(71) Applicants: Brian R. Olson, Fort Qu'Appelle (CA); Theresa Batke, Fort Qu'Appelle (CA)

(72) Inventors: Brian R. Olson, Fort Qu'Appelle (CA); Theresa Batke, Fort Qu'Appelle (CA)

(21) Appl. No.: 17/566,867

(22) Filed: Dec. 31, 2021

(30) Foreign Application Priority Data
Aug. 24, 2021 (CA) 3128830
Oct. 20, 2021 (CA) 3135461

(51) Int. Cl. B60Q 1/26; B60Q 1/46; F21V 21/26

(52) U.S. Cl. CPC B60Q 1/2692; B60Q 1/46; B60Q 1/2657; F21V 21/26

(57) ABSTRACT

A warning system for a work vehicle includes an arm mount attached to a side portion of the work vehicle above a head of a person standing on a ground surface adjacent to the side portion of the work vehicle, and an arm attached to the arm mount. The arm is movable from an arm transport position, where the arm is oriented inside a path of the work vehicle, to an arm operating position, where the arm extends laterally outward from the side portion of the work vehicle. A warning light is mounted on the arm and is visible to traffic approaching the work vehicle from a rear end of the work vehicle, and a work light on the arm shines downward on the operator to illuminate the person the oncoming traffic and to facilitate operation of controls.

This disclosure relates to the field of safety equipment and in particular a warning system for motorists that a person is working adjacent to the road.

### BACKGROUND

Roadside operations can be hazardous to those performing the operations, such as tow truck drivers. These drivers must often stand beside the tow truck to operate winches and like equipment, and are so are exposed to traffic on the adjacent roadway. Such a position is precarious, especially at night or in conditions of low visibility.

### SUMMARY OF THE INVENTION

The present disclosure provides a warning system for roadside operations that overcomes problems in the prior art.

In a first embodiment the present disclosure provides a warning system for a work vehicle. The warning system comprises an arm mount attached to a side portion of the work vehicle above a head of a person standing on a ground surface adjacent to the side portion of the work vehicle, and an arm attached to the arm mount. The arm is movable from an arm transport position, where the arm is oriented inside a path of the work vehicle, to an arm operating position, where the arm extends laterally outward from the side portion of the work vehicle. A warning light mounted on the arm and visible to traffic approaching the work vehicle from a rear end of the work vehicle.

In a second embodiment the present disclosure provides a method of warning traffic that a person operating a work vehicle is working adjacent to a roadway. The method comprises movably attaching an arm to an arm mount attached to an upper portion of a side portion of the work vehicle above a head of the person standing on a ground surface adjacent to the side portion of the work vehicle; moving the arm from a transport position, where the arm is oriented inside a path of the work vehicle, to an operating position, where the arm extends laterally outward from the side portion of the work vehicle above the head of the person; operating a warning light mounted on the arm such that the warning light is visible to traffic approaching the work vehicle from a rear end of the work vehicle.

The present disclosure provides a system and method for warning traffic that a person operating a work vehicle is working adjacent to a roadway. The system is convenient and easy to use, as the arm with the warning light is conveniently is attached to the work vehicle itself, and simply folds out above the person's head to warn traffic. An adjustable work light is included on the arm and shines downward on the operator to show traffic the operator is there, and facilitates working controls and the like

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic side view of an embodiment of the system of the present disclosure;

FIG. 2 is a schematic rear view of the embodiment of FIG. 1;

FIG. 3 is a schematic bottom view of the arm and work light of the embodiment of FIG. 1;

FIG. 4 is a schematic sectional view of the shaft and tube of the mast of the embodiment of FIG. 1 with the arm shown in the arm operating position;

FIG. 5 is a schematic rear view of the shaft and tube of the mast in the arm operating position as shown in FIG. 4;

FIG. 6 is a schematic sectional view of the shaft and tube of the mast of the embodiment of FIG. 1 with the arm shown in the arm transport position;

FIG. 7 is a schematic rear view of the shaft and tube of the mast in the arm transport position as shown in FIG. 6;

FIG. 8 is a schematic top view of an alternate arm mount.

### DETAILED DESCRIPTION OF THE ILLUSTRATED EMBODIMENTS

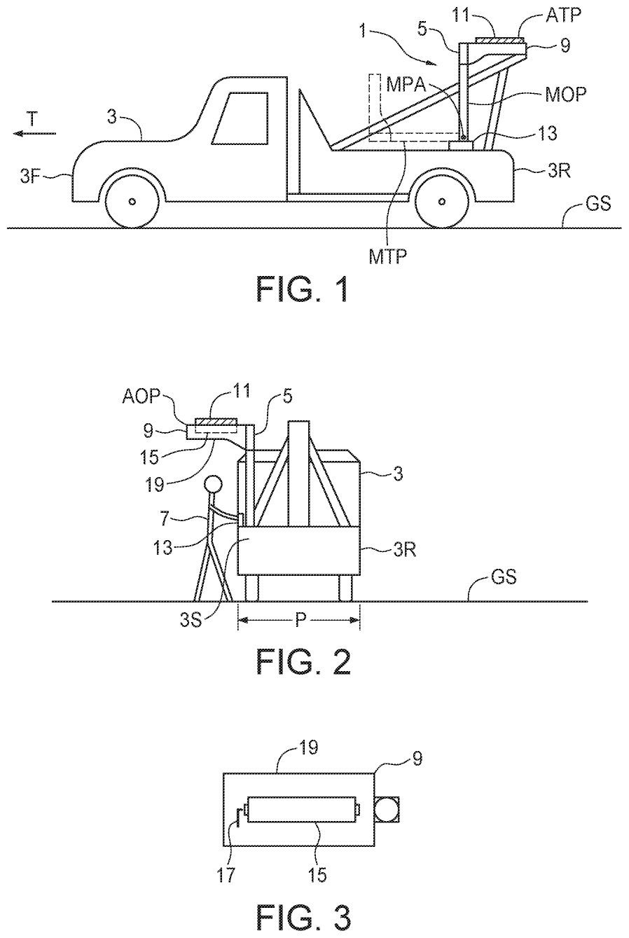

FIG. 1 illustrates an embodiment of a warning system 1 for a work vehicle 3 of the present disclosure. The warning system 1 comprises an arm mount 5 attached to a side portion 3S of the work vehicle 3 above a head of a person 7 standing on a ground surface adjacent to the side portion of the work vehicle 3, and an arm 9 attached to the arm mount 5.

The arm 9 is movable from an arm transport position ATP shown in the side view of FIG. 1 where the arm 9 is oriented inside a path P of the work vehicle 3, to an arm operating position AOP shown in the rear view of FIG. 2, where the arm 9 extends laterally outward from the side portion 3S of the work vehicle 3. A warning light 11, preferably a flashing light, is mounted on the arm 9 and is visible to traffic approaching the work vehicle 3 from a rear end 3R of the work vehicle 3, and also from the a front end 3F of the work vehicle 3F.

FIG. 1 shows the arm in an arm transport position ATP that is substantially aligned with the operating travel direction T of the work vehicle 3, however, as shown in FIG. 8, the arm transport position can be directly opposite the arm transport position at arm transport position ATP′ as shown or where convenient in any location that orients the arm 9 somewhere inside the path of the work vehicle 3 such that the arm 9 does not extend laterally from the work vehicle 3.

The work vehicle 3 comprises vehicle controls 13, such as to control winches and the like, mounted on the side portion 3S of the work vehicle 3, and the arm 9 extends over the vehicle controls 13 when in the arm operating position AOP, with the warning light 11 above the person 7 to warn approaching traffic of the presence of the person 7.

The system 1 also includes a work light 15 mounted on the arm 9 and oriented to shine downward from the arm 9 to illuminate the person 7 operating the controls 13 to oncoming traffic. The orientation of the work light 15 can be adjusted with handle 17, as shown in the bottom view of the arm 9 and work light 15 as shown in FIG. 3.

The work light 15 is enclosed in side panels 19 extending downward along the arm 9 and so is not visible to traffic approaching the work vehicle 7.

The arm 9 mount is attached to a mast 21, and the mast 21 is pivotally mounted to mast pivot axis MPA and is movable from a mast transport position MTP shown dashed lines in FIG. 1 sloping downward in the operating travel direction T of the work vehicle 3 to a mast operating position MOP extending upward from the work vehicle 3 as shown in FIG. 1. It can be seen that with the mast 21 in the mast transport position MTP, the work light 15 can be operated to illuminate objects to the rear of the work vehicle 3. With a work vehicle 3 such as a tow truck, it is common to be necessary to back up toward a disabled vehicle at night and the work light facilitates that operation.

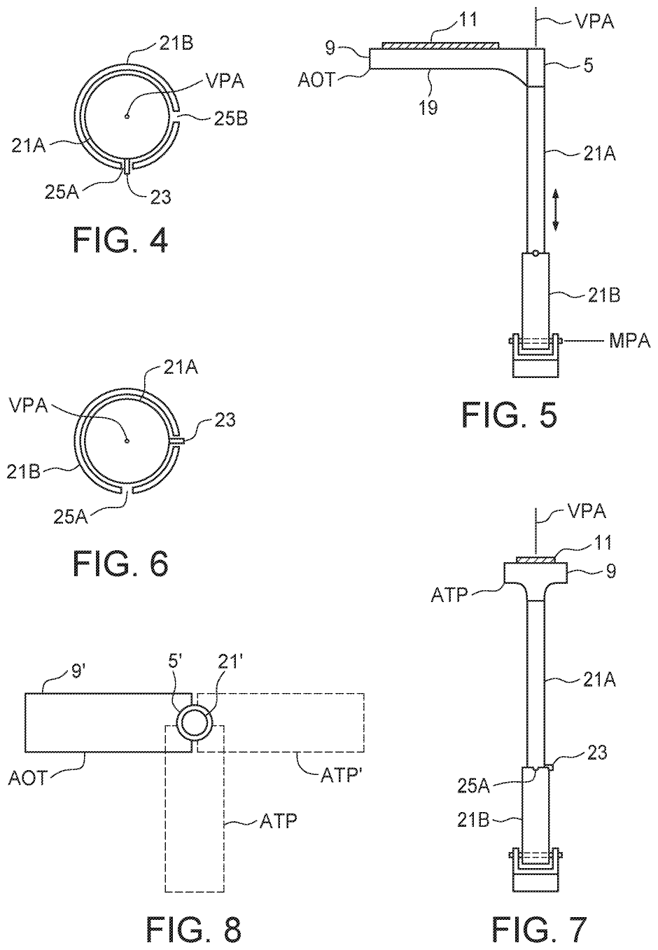

FIGS. 4 and 5 schematically illustrate the mast 21 pivotally mounted to the work vehicle 3 about a substantially vertical pivot axis VPA and where arm 9 is fixed to the mast 21 and the mast 21 pivots about the vertical pivot axis VPA to move the arm 9 from the arm transport position ATP to the arm operating position AOP. The mast 21 comprises a shaft 21A rotatable in a substantially vertically oriented tube 21B, and the shaft 21A is also movable vertically with respect to the tube 21B. A pin 23 extends outward from the shaft 21A.

A first notch 25A in an upper rim of the tube 23B is configured such that, when the pin 23 is placed in the first notch 25A, the arm 9 is in the arm operating position AOP.

To move the arm 9 to the arm transport position ATP the shaft 21A is moved upward out of the first notch 25A and rotated to put the pin 23 down into a second notch 25B where the arm 9 is in the arm transport position ATP.

FIG. 8 schematically illustrates an alternate arrangement where the arm mount 5′ is pivotally mounted to the mast 21′ and wherein the arm mount 5′ pivots about the mast 21′ to move the arm 9′ from the arm transport position ATP to the arm operating position AOP.

The present disclosure further provides a method of warning traffic that a person 7 operating a work vehicle 3 is working adjacent to a roadway. The method comprises movably attaching an arm 9 to an arm mount 5 attached to an upper portion of a side portion 3S of the work vehicle 3 above a head of a person 7 standing on a ground surface GS adjacent to the side portion of the work vehicle; moving the arm 9 from a arm transport position ATP, where the arm 9 is substantially aligned with an operating travel direction T of the work vehicle 3, to an arm operating position AOP, where the arm 9 extends laterally outward from the side portion 3S of the work vehicle 2 above the head of the person 7; and operating a warning light 11 mounted on the arm 9 such that the warning light 11 is visible to traffic approaching the work vehicle 3 from a rear end of the work vehicle 3.

The present disclosure provides a system and method for warning traffic that a person 7 operating a work vehicle 3 is working adjacent to a roadway that is convenient and easy to use. The arm 9 with the warning light 11 is conveniently is attached to the work vehicle 3 itself, and simply folds out above the person's head to warn traffic, and includes a work light 15 to shine down on the person 7 operating the controls 13 to further warn traffic of his presence, and to facilitate working controls and the like.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A warning system for a work vehicle, the warning system comprising:
an arm mount attached to a side portion of the work vehicle above a head of a person standing on a ground surface adjacent to the side portion of the work vehicle, and an arm attached to the arm mount;
wherein the arm is movable from an arm transport position, where the arm is oriented inside a path of the work vehicle, to an arm operating position, where the arm extends laterally outward from the side portion of the work vehicle;
a warning light mounted on the arm and visible to traffic approaching the work vehicle from a rear end of the work vehicle.

2. The apparatus of claim 1 wherein when in the arm operating position, the warning light is visible to traffic approaching the work vehicle from a front end of the work vehicle.

3. The apparatus of claim 1 wherein the work vehicle comprises vehicle controls mounted on the side portion of the work vehicle, and wherein the arm extends over the vehicle controls when in the arm operating position

4. The apparatus of claim 1 wherein the warning light comprises a flashing light.

5. The apparatus of claim 1 further comprising a work light mounted on the arm and oriented to shine downward from the arm.

6. The system of claim 5 wherein the orientation of the work light is adjustable.

7. The system of claim 6 wherein the work light is enclosed in side panels extending downward along the arm and is not visible to traffic approaching the work vehicle.

8. The apparatus of claim 1 wherein the arm mount is attached to a mast, and wherein the mast is movable from a mast transport position sloping downward to a mast operating position extending upward from the work vehicle.

9. The system of claim 8 wherein the mast is pivotally mounted to the work vehicle about a substantially vertical pivot axis and wherein the mast pivots about the vertical pivot axis to move the arm from the arm transport position to the arm operating position.

10. The system of claim 9 wherein the mast comprises:
a shaft rotatable in a substantially vertically oriented tube, wherein the shaft is movable vertically with respect to the tube;
a pin extending outward from the shaft;
a first notch in an upper rim of the tube configured such that, when the pin is the first notch, the arm is in the arm operating position;
a second notch in the upper rim of the tube configured such that, when the pin is the second notch, the arm is in the arm transport position.

11. The system of claim 8 wherein the arm mount is pivotally mounted to the mast and wherein the arm mount pivots about the mast to move the arm from the arm transport position to the arm operating position.

12. A method of warning traffic that a person operating a work vehicle is working adjacent to a roadway, the method comprising:
movably attaching an arm to an arm mount attached to an upper portion of a side portion of the work vehicle above a head of the person standing on a ground surface adjacent to the side portion of the work vehicle;
moving the arm from a transport position, where the arm is oriented inside a path of the work vehicle, to an operating position, where the arm extends laterally outward from the side portion of the work vehicle above the head of the person;
operating a warning light mounted on the arm such that the warning light is visible to traffic approaching the work vehicle from a rear end of the work vehicle.

13. The method of claim 12 wherein when in the arm operating position, the warning light is visible to traffic approaching the work vehicle from a front end of the work vehicle.

14. The method of claim 13 comprising providing a work light oriented to shine downward from the arm.

15. The system of claim 14 wherein the orientation of the work light is adjustable.

16. The method of claim 12 wherein the warning light flashes.
